(19) United States
(12) Patent Application Publication
(10) Pub. No.: US 2025/0015295 A1
(43) Pub. Date: Jan. 9, 2025

(54) NEGATIVE ELECTRODE AND ZINC SECONDARY BATTERY

(71) Applicant: NGK INSULATORS, LTD., Nagoya-shi (JP)

(72) Inventors: Hiroshi MATSUBAYASHI, Suzuka-City (JP); Sota SHIMIZU, Nagoya-City (JP); Toshiki HIRAIWA, Iwakura-City (JP); Eiichi HIRAYAMA, Nagoya-City (JP)

(21) Appl. No.: 18/890,967

(22) Filed: Sep. 20, 2024

Related U.S. Application Data
(63) Continuation of application No. PCT/JP2022/040191, filed on Oct. 27, 2022.

(30) Foreign Application Priority Data
Mar. 23, 2022 (JP) 2022-047640

(51) Int. Cl. H01M 4/62; H01M 4/02; H01M 4/24; H01M 4/36; H01M 4/38; H01M 4/48; H01M 10/30; H01M 10/42; H01M 12/08

(52) U.S. Cl. CPC H01M 4/628; H01M 4/244; H01M 4/364; H01M 4/366; H01M 4/38; H01M 4/48; H01M 10/30; H01M 10/4235; H01M 12/08; H01M 2004/027

(57) ABSTRACT

Provided is a negative electrode for use in a zinc secondary battery, including ZnO particles, metallic Zn particles having an average particle diameter D50 of 85 to 250 μm, and Bi₂O₃ particles having an average major axis diameter of 0.3 to 8.5 μm, in which the content of the metallic Zn particles is 1.0 to 87.5 parts by weight and the content of the Bi₂O₃ particles is 0.5 to 20 parts by weight, based on the content of the ZnO particles being 100 parts by weight.

### CROSS-REFERENCE TO RELATED APPLICATIONS

This application is a continuation application of PCT/JP2022/040191 filed Oct. 27, 2022, which claims priority to Japanese Patent Application No. 2022-047640 filed Mar. 23, 2022, the entire contents all of which are incorporated herein by reference.

### BACKGROUND OF THE INVENTION

### 1. Field of the Invention

The present invention relates to a negative electrode and a zinc secondary battery.

### 2. Description of the Related Art

In zinc secondary batteries such as nickel-zinc secondary batteries, air-zinc secondary batteries, etc., metallic zinc precipitates from a negative electrode in the form of dendrites upon charging, and penetrates into voids of a separator such as a nonwoven fabric and reaches a positive electrode, which is known to result in bringing about short-circuiting. The short circuit due to such zinc dendrites shortens the life in repeated charge/discharge cycles.

In order to deal with the above issues, batteries comprising layered double hydroxide (LDH) separators that prevent penetration of zinc dendrites while selectively permeating hydroxide ions, have been proposed. For example, Patent Literature 1 (WO2013/118561) discloses that an LDH separator is provided between a positive electrode and a negative electrode in a nickel-zinc secondary battery. Moreover, Patent Literature 2 (WO2016/076047) discloses a separator structure comprising an LDH separator fitted or joined to a resin outer frame, and discloses that the LDH separator has a high density to the degree that it has gas impermeability and/or water impermeability. Moreover, this literature also discloses that the LDH separator can be composited with porous substrates. Further, Patent Literature 3 (WO2016/067884) discloses various methods for forming an LDH dense membrane on a surface of a porous substrate to obtain a composite material. This method comprises steps of uniformly adhering a starting material that can impart a starting point for LDH crystal growth to a porous substrate and subjecting the porous substrate to hydrothermal treatment in an aqueous solution of raw materials to form the LDH dense membrane on the surface of the porous substrate.

By the way, another factor that shortens the life of a zinc secondary battery includes a morphological change of zinc which is a negative electrode active material. More specifically, as zinc repeatedly dissolves and precipitates due to repeated charge and discharge, the negative electrode changes its morphology, causing high resistance due to clogging of pores, a decrease in a charge active material due to accumulation of isolated zinc, and the like, which results in difficulty in charge and discharge. In order to address this problem, Patent Literature 4 (WO2020/049902) proposes using as a negative electrode, a combination of ZnO particles and at least two selected from the group consisting of (i) metal Zn particles with a predetermined particle size, (ii) a predetermined metal element, and (iii) a binder resin having a hydroxyl group. According to this negative electrode, it is inhibited from being deteriorated due to repeated charge/discharge cycles to improve its durability in a zinc secondary battery, thereby enabling prolongation of a cycle life.

Moreover, Patent Literature 5 (JP2021-57339A) discloses use of solder as an electrically conductive aid together with Zn particles and ZnO particles in a negative electrode, which is said to inhibit deterioration of the negative electrode in a zinc secondary battery accompanying repeated charging and discharging then to improve its durability, thereby enabling prolonging the cycle life. The literature also discloses that the solder preferably contains at least one selected from the group consisting of Sn, Pb, Bi, In, and Zn.

### CITATION LIST

### Patent Literature

Patent Literature 1: WO2013/118561
Patent Literature 2: WO2016/076047
Patent Literature 3: WO2016/067884
Patent Literature 4: WO2020/049902
Patent Literature 5: JP2021-57339A

### SUMMARY OF THE INVENTION

As disclosed in Patent Literatures 4 and 5, various attempts have been proposed to address lowering of cycle characteristics accompanying a morphological change of a zinc negative electrode; however, further improvement of cycle characteristics has been required.

The present inventors have recently found that a cycle life in a zinc secondary battery can be prolonged by using a mixture containing the predetermined amount of Bi₂O₃ particles having a predetermined average major axis diameter together with ZnO particles and Zn particles in a negative electrode.

Therefore, an object of the present invention is to provide a negative electrode capable of prolonging the cycle life of a zinc secondary battery.

The present invention provides the following aspects:

### [Aspect 1]

A negative electrode for use in a zinc secondary battery, comprising:
ZnO particles,
metallic Zn particles having an average particle diameter D50 of 85 to 250 μm, and
Bi₂O₃ particles having an average major axis diameter of 0.3 to 8.5 μm,
wherein the content of the metallic Zn particles is 1.0 to 87.5 parts by weight and the content of the Bi₂O₃ particles is 0.5 to 20 parts by weight, based on the content of the ZnO particles being 100 parts by weight.

### [Aspect 2]

The negative electrode according to aspect 1, wherein the content of the Bi₂O₃ particles is 1.2 to 13.6 parts by weight, based on the content of the ZnO particles being 100 parts by weight.

### [Aspect 3]

The negative electrode according to aspect 1 or 2, wherein the Bi₂O₃ particles have the average major axis diameter of 1.2 to 8.5 μm.

### [Aspect 4]

The negative electrode according to any one of aspects 1 to 3, wherein the Bi₂O₃ particles have a maximum major axis diameter of less than 35 μm.

### [Aspect 5]

The negative electrode according to any one of aspects 1 to 4, wherein the Bi₂O₃ particles are present on a surface of the ZnO particles.

### [Aspect 6]

The negative electrode according to any one of aspects 1 to 5, wherein the Bi₂O₃ particles are comprised in the form of non-aggregated primary particles.

### [Aspect 7]

The negative electrode according to any one of aspects 1 to 6, wherein the negative electrode is a sheet-like pressed product.

### [Aspect 8]

A zinc secondary battery, comprising:
a positive electrode,
the negative electrode according to any one of aspects 1 to 7,
a separator separating the positive electrode from the negative electrode so as to be capable of conducting hydroxide ions therethrough, and
an electrolytic solution.

### [Aspect 9]

The zinc secondary battery according to aspect 8, wherein the separator is an LDH separator comprising a layered double hydroxide (LDH) and/or an LDH-like compound.

### [Aspect 10]

The zinc secondary battery according to aspect 9, wherein the LDH separator is composited with a porous substrate.

### [Aspect 11]

The zinc secondary battery according to any one of aspects 8 to 10, wherein the positive electrode comprises nickel hydroxide and/or nickel oxyhydroxide whereby the zinc secondary battery forms a nickel-zinc secondary battery.

### [Aspect 12]

The zinc secondary battery according to any one of aspects 8 to 10, wherein the positive electrode is an air electrode whereby the zinc secondary battery forms a zinc-air secondary battery.

### BRIEF DESCRIPTION OF THE DRAWINGS

FIG. 1A is a schematic view illustrating an example of Bi₂O₃ particles present on a surface of a metallic Zn particle in a negative electrode, wherein the Bi₂O₃ particles have a small particle diameter.

FIG. 1B is a schematic view illustrating another example of Bi₂O₃ particles present on a surface of a metallic Zn particle in a negative electrode, wherein the Bi₂O₃ particles have a particle diameter within a desirable range.

FIG. 1C is a schematic view illustrating the other example of Bi₂O₃ particles present on a surface of a metallic Zn particle in a negative electrode, wherein the Bi₂O₃ particles have a larger particle diameter.

FIG. 2A is SEM images of Bi₂O₃ powder used in Examples 1 to 11, the image explaining a major axis diameter.

FIG. 2B is an image explaining a calculation method of a major axis diameter in the SEM image in FIG. 2A.

FIG. 3 is a cross-sectional SEM image of the negative electrode acquired in Example 14.

FIG. 4 is a cross-sectional SEM image of the negative electrode acquired in Example 20.

### DETAILED DESCRIPTION OF THE INVENTION

### Negative Electrode

The negative electrode of the present invention is a negative electrode used in zinc secondary batteries. The negative electrode contains ZnO particles, metallic Zn particles, and Bi₂O₃ particles. The average particle diameter D50 of the metallic Zn particles is 85 to 250 μm. The average major axis diameter of Bi₂O₃ particles is 0.3 to 8.5 μm. In addition, the content of metallic Zn particles is 1.0 to 87.5 parts by weight and the content of Bi₂O₃ particles is 0.5 to 20 parts by weight, based on the content of ZnO particles being 100 parts by weight. Using a mixture containing the predetermined amount of Bi₂O₃ particles having a predetermined average major axis diameter together with ZnO particles and Zn particles in the negative electrode, enables prolonged cycle life in a zinc secondary battery.

The mechanism whereby the addition of Bi₂O₃ particles to the negative electrode improves cycle characteristics of a zinc secondary battery, is not necessarily clear, but examples of one of the factors include the following. First, when a zinc negative electrode containing Bi₂O₃ particles is immersed in an electrolytic solution (for example, a strong alkaline electrolytic solution), the following local battery reactions occur, reducing Bi₂O₃ to Bi. It is noted that when Bi₂O₃ powder is immersed singly in the electrolytic solution, the reactions described below do not occur due to the absence of Zn. In other words, the below reactions are said to be unique to a negative electrode.

Bi₂O₃+3H₂O+6e⁻→2Bi+6OH⁻ Cathode reaction

3Zn+12OH⁻→3Zn(OH)₄²⁻+6e⁻ Anode reaction

3Zn(OH)₄²⁻→3ZnO+6OH⁻+3H₂O

In addition, a discharging reaction at the negative electrode is as shown below, and a charging reaction is the opposite.

Zn+4OH⁻→Zn(OH)₄²⁻+2e⁻

Zn(OH)₄²⁻→ZnO+2OH⁻+H₂O

On the other hand, upon charging and discharging, an overcharge reaction of a negative electrode and a self-decomposition reaction of metallic Zn can occur in a zinc negative electrode, as undesirable side reactions described below, in addition to the above reactions. It is noted that all of the side reactions shown below occur on a surface of metallic Zn particles.

2H₂O+2e⁻→H₂+2OH⁻ Overcharge reaction of a negative electrode

Zn+H₂O→H₂+ZnO Self-decomposition reaction of metallic Zn

In this regard, Bi present on the surface of the metallic Zn particles increases a hydrogen generation overvoltage, making it possible to effectively inhibit the overcharge reaction and self-discharge reaction. As a result, it is considered that in a zinc secondary battery, deterioration of the negative electrode due to repeated charge/discharge cycles can be inhibited to improve the durability, so that the cycle life can be prolonged. Therefore, the negative electrode desirably has Bi₂O₃ particles present on the surface of ZnO particles.

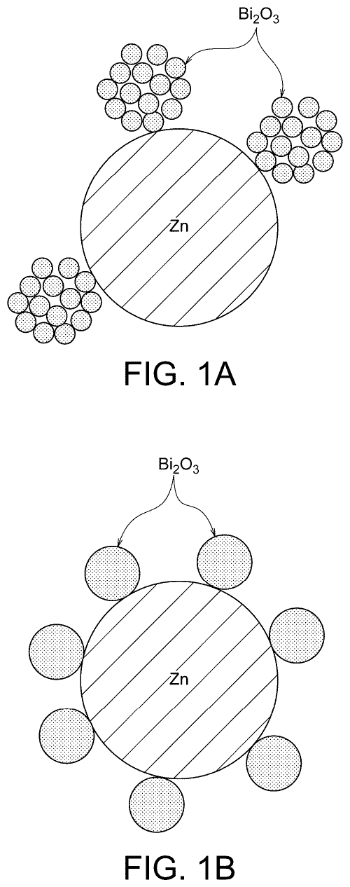

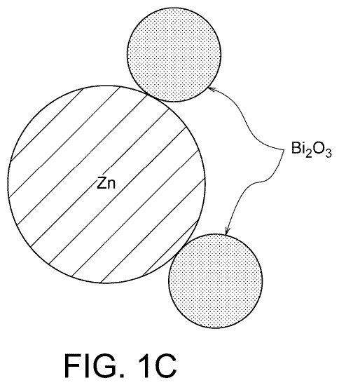

The aforementioned inhibition of hydrogen generation is effectively demonstrated by controlling the average major axis diameter of Bi₂O₃ particles to 0.3 to 8.5 μm. FIGS. 1A to 1C are schematic views representing the state of Bi₂O₃ particles present on a surface of a metallic Zn particle. The Bi₂O₃ particles shown in FIG. 1A have a too small particle diameter (average major axis diameter: smaller than 0.3 μm), so that the particles are significantly likely to aggregate with each other, and the abundance of Bi₂O₃ particles on the metallic Zn particle surface becomes small. In addition, the Bi₂O₃ particles shown in FIG. 1C have a too large particle diameter (average major axis diameter: larger than 8.5 μm), so that the particles aggregate less with each other; however, the number of Bi₂O₃ particles present on the metallic Zn particle surface is reduced, resulting in the smaller abundance of Bi₂O₃ particles on the metallic Zn particle surface. In contrast, the Bi₂O₃ particles shown in FIG. 1B have an average major axis diameter of 0.3 to 8.5 μm, allowing both the aggregation of particles and the number of particles present on the metallic Zn particle surface to be controlled within desirable ranges, resulting in the larger abundance of Bi₂O₃ particles on the metallic Zn particle surface. Therefore, it is considered that the use of the negative electrode containing Bi₂O₃ particles having such an average major axis diameter in a zinc secondary battery would increase an inhibition effect of hydrogen generation and contribute to improvement in cycle characteristics. Therefore, the negative electrode desirably has Bi₂O₃ particles contained in the form of non-aggregated primary particles (single particles). Criteria for determining the presence or absence of aggregation shall be described in Example described below.

From the above viewpoint, the average major axis diameter of Bi₂O₃ particles is 0.3 to 8.5 μm, preferably 1.2 to 8.5 μm, more preferably 2.0 to 7.5 μm, further preferably 2.7 to 6.5 μm, and particularly preferably 3.5 to 5.0 μm. The “major axis diameter” in the present invention is defined as referring to a length of a long side of a particle. The average major axis diameter can be calculated by observing Bi₂O₃ powder with a commercially available scanning electron microscope (SEM). A preferred method for calculating the average major axis diameter using SEM shall be described in Example described below. It is noted that the reason for evaluating a size of Bi₂O₃ particle using the average major axis diameter rather than the average particle diameter D50 or the like, is as follows. Namely, a particle size distribution analyzer is usually used to calculate the average particle diameter D50; however, this particle size distribution measurement is affected by the aggregated particles described above. For this reason, the present invention employs the average major axis diameter as an index capable of more accurately evaluating a size of primary particle of Bi₂O₃.

The maximum major axis diameter of Bi₂O₃ particle is preferably smaller than 35 μm, more preferably 2.5 to 30 μm, further preferably 5.0 to 25 μm, and particularly preferably 10 to 20 μm. However, this maximum major axis diameter shall be the average major axis diameter described above or larger. Controlling the maximum major axis diameter of Bi₂O₃ particles in such a manner to narrow its particle size distribution, enables further improving the cycle characteristics of a zinc secondary battery. The maximum major axis diameter can be calculated by observing Bi₂O₃ powder with a commercially available scanning electron microscope (SEM). A preferred method for calculating the maximum major axis diameter using SEM shall be described in Example described below.

The content of Bi₂O₃ particles in a negative electrode is 0.5 to 20 parts by weight, preferably 1.2 to 13.6 parts by weight, more preferably 1.2 to 10.1 parts by weight, further preferably 1.2 to 6.6 parts by weight, particularly preferably 1.2 to 4.5 parts by weight, most preferably 1.2 to 3.3 parts by weight, based on the content of ZnO particles being 100 parts by weight. In such a manner, a cycle life in a zinc secondary battery can be prolonged.

The negative electrode may contain metallic Bi particles. As described above, when the negative electrode is immersed in an electrolytic solution, the Bi₂O₃ particles are considered to be partially or entirely converted to metallic Bi. In this regard, an embodiment in which the negative electrode was immersed in an electrolytic solution for use in a zinc secondary battery and the Bi₂O₃ particles were partially or entirely converted to metallic Bi particles, shall also be included in the scope of the negative electrode of the present invention. In addition, in a case in which the negative electrode contains metallic Bi particles (including the case where Bi₂O₃ particles have been converted to metallic Bi particles), upon conversion of the content of metallic Bi to that of Bi₂O₃, it shall be then included in the above content of Bi₂O₃ particles.

The average particle diameter D50 of metallic Zn particles is 85 to 250 μm, preferably 85 to 200 μm, more preferably 85 to 180 μm, further preferably 90 to 160 μm, and particularly preferably 90 to 130 μm. Note, however, the average particle diameter D50 used herein shall refer to a particle diameter at which the integrated volume from the small particle diameter side reaches 50% in a particle size distribution obtained by a laser diffraction and scattering method. The content of metallic Zn particles in a negative electrode is also 1.0 to 87.5 parts by weight, preferably 2.0 to 80 parts by weight, more preferably 3.0 to 70 parts by weight, further preferably 4.0 to 62.5 parts by weight, and particularly preferably 5.0 to 55 parts by weight, based on the content of ZnO particles being 100 parts by weight.

The ZnO particles are not particularly limited as long as they are commercially available zinc oxide powder used in a zinc secondary battery, or zinc oxide powder grown by a solid phase reaction or the like using them as starting materials. The average particle diameter D50 of the ZnO particles is preferably 0.1 to 20 μm, more preferably 0.1 to 15 μm, and further preferably 0.3 to 12 μm.

Negative electrode may further contain a binder. The negative electrode comprising the binder maintains the shape of the negative electrode more easily. Various known binders can be used as the binder and a preferable example thereof is polytetrafluoroethylene (PTFE). PVA and PTFE are both particularly preferably combined for use as binders.

Negative electrode may further contain a conductive aid. Examples of the conductive aid include carbon, metal powders (tin, lead, copper, cobalt, and the like), and noble metal pastes

The negative electrode is preferably a sheet-like pressed product. Such a manner can contemplate prevention of electrode active material from falling off and improvement in the electrode density, making it possible to effectively inhibit the morphological change of the negative electrode. Such a sheet-like pressed product can be fabricated by adding a binder to a negative electrode material followed by kneading, and pressing the obtained kneaded product by a roll press machine, etc., into a sheet.

The negative electrode is preferably provided with a current collector. Preferred examples of the current collector include a copper punching metal and a copper expanded metal. In this case, for example, a negative electrode plate composed of a negative electrode/negative electrode current collector can be favorably fabricated by coating a surface of a copper punching metal or a copper expanded metal with a mixture containing a Zn compound, metallic zinc and zinc oxide powder, as well as a binder (for example, polytetrafluoroethylene particles), if necessary. At this time, the negative electrode plate (i.e., the negative electrode/negative electrode current collector) after drying is also preferably subjected to press treatment to contemplate prevention of the negative electrode active material from falling off and improvement in the electrode density. Alternatively, the sheet-like pressed product as described above may be compressed and bonded to a current collector such as a copper expanded metal.

### Zinc Secondary Battery

The negative electrode of the present invention is preferably applied to a zinc secondary battery. Therefore, according to a preferred embodiment of the present invention, a zinc secondary battery comprising a positive electrode, a negative electrode, a separator separating the positive electrode from the negative electrode so as to be capable of conducting hydroxide ions therethrough, and an electrolytic solution, is provided. The zinc secondary battery of the present invention is not particularly limited provided that it is a secondary battery in which negative electrode described above is used and an electrolytic solution (typically an aqueous alkali metal hydroxide solution) is used. Therefore, it can be a nickel-zinc secondary battery, a silver oxide-zinc secondary battery, a manganese oxide-zinc secondary battery, a zinc-air secondary battery, or various other alkaline-zinc secondary batteries. For example, a positive electrode preferably comprises nickel hydroxide and/or nickel oxyhydroxide whereby the zinc secondary battery forms a nickel-zinc secondary battery. Alternatively, the positive electrode may be an air electrode whereby the zinc secondary battery forms a zinc-air secondary battery.

The separator is preferably a layered double hydroxide (LDH) separator. As described above, LDH separators have been known in the field of nickel-zinc secondary batteries or zinc-air secondary batteries (see Patent Literatures 1 to 3), and an LDH separator can also be preferably used for the zinc secondary battery of the present invention. The LDH separator can prevent the penetration of zinc dendrites while selectively allowing hydroxide ions to permeate. Combined with the effect of adopting the negative electrode of the present invention, the durability of the zinc secondary battery can be further improved. Incidentally, the LDH separator herein is defined as a separator including a layered double hydroxide (LDH) and/or an LDH-like compound (hereinafter collectively referred to as a hydroxide ion-conducting layered compound), which selectively passes hydroxide ions by exclusively utilizing hydroxide ion conductivity of the hydroxide ion-conducting layered compound. The “LDH-like compound” herein, although it may not be called an LDH, is hydroxide and/or oxide with a layered crystal structure analogous to LDH, and can be considered as an equivalent of LDH. In a broader definition, however, “LDH” can also be interpreted to include not only LDH but also the LDH-like compound.

The LDH separator may be composited with porous substrates as disclosed in Patent Literatures 1 to 3. The porous substrate may be composed of any of ceramic materials, metallic materials, and polymer materials; however, it is particularly preferably composed of the polymer materials. The polymer porous substrate has advantages of 1) flexibility (hence, it is hard to break even if being thin), 2) facilitation of increase in porosity, 3) facilitation of an increase in conductivity (because it can be rendered thin while increasing porosity), and 4) facilitation of manufacture and handling. The polymer material is particularly preferably polyolefins such as polypropylene, polyethylene, etc., and most preferably polypropylene, in terms of excellent hot-water resistance, excellent acid resistance and excellent alkali resistance as well as low cost. When the porous substrate is composed of the polymer material, a hydroxide ion-conducting layered compound is particularly preferably incorporated over the entire region of the thickness direction of the porous substrate (for example, most or almost all the pores inside the porous substrate are filled with the hydroxide ion-conducting layered compound). In this case, the thickness of the polymer porous substrate is preferably 5 to 200 μm, more preferably 5 to 100 μm, and still more preferably 5 to 30 μm. A microporous membrane that is commercially available as a separator for lithium batteries can be preferably used as such polymer porous substrates.

The electrolytic solution preferably comprises an alkali metal hydroxide aqueous solution. The alkali metal hydroxide includes, for example, potassium hydroxide, sodium hydroxide, lithium hydroxide, ammonium hydroxide, etc., however, potassium hydroxide is more preferred. Zinc oxide, zinc hydroxide, etc., may be added to the electrolytic solution in order to inhibit spontaneous dissolution of the zinc-containing material.

### LDH-Like Compound

According to a preferred aspect of the present invention, the LDH separator can be such that it contains an LDH-like compound; the definition of the LDH-like compound is as described above. A preferred LDH-like compound is as follows:
(a) Hydroxide and/or oxide with a layered crystal structure containing Mg and one or more elements with at least Ti, selected from the group consisting of Ti, Y, and Al; or
(b) hydroxide and/or oxide with a layered crystal structure containing (i) Ti, Y, and optionally Al and/or Mg and (ii) an additive element M that is at least one type selected from the group consisting of In, Bi, Ca, Sr and Ba; or
(c) hydroxide and/or oxide with a layered crystal structure containing Mg, Ti, Y, and optionally Al and/or In, wherein the LDH-like compound is present in the form of a mixture with In(OH)₃ in (c).

According to the preferred aspect (a) of the present invention, the LDH-like compound can be hydroxide and/or oxide with a layered crystal structure containing Mg and one or more elements with at least Ti, selected from the group consisting of Ti, Y, and Al. Thus, a typical LDH-like compound is complex hydroxide and/or complex oxide of Mg, Ti, optionally Y, and optionally Al. The aforementioned elements may be replaced by other elements or ions to the extent that the basic characteristics of the LDH-like compound are not impaired; however, the LDH-like compound is preferably free of Ni. For example, the LDH-like compound may be such that it further contains Zn and/or K. This can further improve the ionic conductivity of the LDH separator.

The LDH-like compound can be identified by X-ray diffraction. Specifically, when an LDH separator undergoes X-ray diffraction on its surface, a peak derived from the LDH-like compound is typically detected in the range of 5°≤2θ≤10° and more typically in the range of 7°≤2θ≤10°. As described above, LDH is a substance with an alternating stacked structure in which exchangeable anions and H₂O are present as an intermediate layer between the stacked hydroxide base layers. In this regard, when an LDH is measured by an X-ray diffraction method, a peak (i.e., the (003) peak of LDH) is essentially detected at the position of 2θ=11 to 12° derived from a crystal structure of LDH. When the LDH-like compound is measured by the X-ray diffraction method, on the contrary, a peak is typically detected in the range described above that is shifted to the lower angle side than the position of the aforementioned peak of LDH. Moreover, using the 2θ corresponding to the peak derived from the LDH-like compound in the X-ray diffraction enables determination of the interlayer distance of the layered crystal structure according to the Bragg formula. The interlayer distance of the layered crystal structure constituting the LDH-like compound determined in such a way is typically 0.883 to 1.8 nm and more typically 0.883 to 1.3 nm.

The LDH separator according to the aspect (a) above has an atomic ratio of Mg/(Mg+Ti+Y+Al) in the LDH-like compound of preferably 0.03 to 0.25 and more preferably 0.05 to 0.2, as determined by energy dispersive X-ray spectroscopy (EDS). Further, the atomic ratio of Ti/(Mg+Ti+Y+Al) in the LDH-like compound is preferably 0.40 to 0.97 and more preferably 0.47 to 0.94. Furthermore, the atomic ratio of Y/(Mg+Ti+Y+Al) in the LDH-like compound is preferably 0 to 0.45 and more preferably 0 to 0.37. In addition, the atomic ratio of Al/(Mg+Ti+Y+Al) in the LDH-like compound is preferably 0 to 0.05 and more preferably 0 to 0.03. The ratios within the above ranges render alkali resistance more excellent and make it possible to more effectively achieve an inhibition effect of short circuits caused by zinc dendrites (i.e., dendrite resistance). By the way, an LDH, which has been conventionally known for an LDH separator, can be represented by the basic composition with the general formula: M²⁺₁₋ₓM³⁺ₓ(OH)₂Aⁿ⁻_{x/n}·mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of the conventional LDH. Incidentally, EDS analysis is preferably carried out with an EDS analyzer (for example, an X-act manufactured by Oxford Instruments) by 1) capturing an image at an accelerating voltage of 20 kV and a magnification of 5,000 times, 2) carrying out a three-point analysis at approximately 5 μm intervals in a point analysis mode, 3) repeating the above 1) and 2) once more, and 4) calculating an average value of a total of 6 points.

According to another preferred aspect (b) of the present invention, the LDH-like compound can be hydroxide and/or oxide with a layered crystal structure containing (i) Ti, Y, and optionally Al and/or Mg, and (ii) additive element M. Thus, a typical LDH-like compound is complex hydroxide and/or complex oxide of Ti, Y, additive element M, optionally Al, and optionally Mg. Additive element M is In, Bi, Ca, Sr, Ba or combinations thereof. The above elements may be replaced by other elements or ions to the extent that the basic characteristics of the LDH-like compound are not impaired; however, the LDH-like compound is preferably free of Ni.

The LDH separator according to the aspect (b) above preferably has an atomic ratio of Ti/(Mg+Al+Ti+Y+M) in the LDH-like compound of 0.50 to 0.85 and more preferably 0.56 to 0.81, as determined by energy dispersive X-ray spectroscopy (EDS). The atomic ratio of Y/(Mg+Al+Ti+Y+M) in the LDH-like compound is preferably 0.03 to 0.20 and more preferably 0.07 to 0.15. The atomic ratio of M/(Mg+Al+Ti+Y+M) in the LDH-like compound is preferably 0.03 to 0.35 and more preferably 0.03 to 0.32. The atomic ratio of Mg/(Mg+Al+Ti+Y+M) in the LDH-like compound is preferably 0 to 0.10 and more preferably 0 to 0.02. In addition, the atomic ratio of Al/(Mg+Al+Ti+Y+M) in the LDH-like compound is preferably 0 to 0.05 and more preferably 0 to 0.04. The ratios within the above ranges render the alkali resistance more excellent and make it possible to more effectively achieve an inhibition effect of short circuits caused by zinc dendrites (i.e., dendrite resistance). By the way, an LDH, which has been conventionally known regarding a LDH separator, can be represented by a basic composition with the general formula: M²⁺₁₋ₓM³⁺ₓ(OH)₂Aⁿ⁻_{x/n}·mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of the conventional LDH. Incidentally, EDS analysis is preferably carried out with an EDS analyzer (for example, an X-act manufactured by Oxford Instruments) by 1) capturing an image at an accelerating voltage of 20 kV and a magnification of 5,000 times, 2) carrying out a three-point analysis at approximately 5 μm intervals in a point analysis mode, 3) repeating the above 1) and 2) once more, and 4) calculating an average value of a total of 6 points.

According to yet another preferred aspect (c) of the present invention, the LDH-like compound can be hydroxide and/or oxide with a layered crystal structure containing Mg, Ti, Y, and optionally Al and/or In, wherein the LDH-like compound is present in the form of a mixture with In(OH)₃. The LDH-like compound of this aspect is hydroxide and/or oxide with a layered crystal structure containing Mg, Ti, Y, and optionally Al and/or In. Thus, a typical LDH-like compound is complex hydroxide and/or complex oxide of Mg, Ti, Y, optionally Al, and optionally In. It is to be noted that In that can be contained in the LDH-like compound may be not only In that is intended to be added to the LDH-like compound, but also In that is unavoidably incorporated into the LDH-like compound derived from the formation of In(OH)₃, or the like. The above elements can be replaced by other elements or ions to the extent that the basic characteristics of the LDH-like compound are not impaired; however, the LDH-like compound is preferably free of Ni. By the way, an LDH, which has been conventionally known regarding a LDH separator, can be represented by a basic composition with the general formula: M²⁺₁₋ₓM³⁺ₓ(OH)₂Aⁿ⁻_{x/n}·mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of a conventional LDH.

The mixture according to the aforementioned aspect (c) contains not only the LDH-like compound but also In(OH)₃ (typically composed of the LDH-like compound and In(OH)₃). Containing In(OH)₃ in the mixture enables effective improvement in the alkali resistance and dendrite resistance of an LDH separator. The content proportion of In(OH)₃ in the mixture is preferably an amount that can improve the alkali resistance and dendrite resistance without impairing hydroxide ion conductivity of an LDH separator, and is not particularly limited. In(OH)₃ may be such that it has a cubic crystalline structure and also has a configuration in which the crystalline of In(OH)₃ is surrounded by the LDH-like compound. The In(OH)₃ can be identified by X-ray diffraction.

### EXAMPLES

The present invention will be described in more detail with reference to the following Examples.

### Examples 1 to 11

### (1) Preparation of Positive Electrode

A paste-type nickel hydroxide positive electrode (capacity density: about 700 mAh/cm³) was prepared.

### (2) Fabrication of Negative Electrode

Various raw material powders shown below were prepared.
ZnO powder (manufactured by Seido Chemical Industry Co., Ltd., JIS Standard Class 1 grade, average particle diameter D50: 0.2 μm)
Metallic Zn powder (average particle diameter D50: 120 μm, manufactured by Dowa Electronics Materials Co., Ltd.)
Bi₂O₃ powder (manufactured by Vital Materials Co., Ltd., average major axis diameter: 0.5 μm)

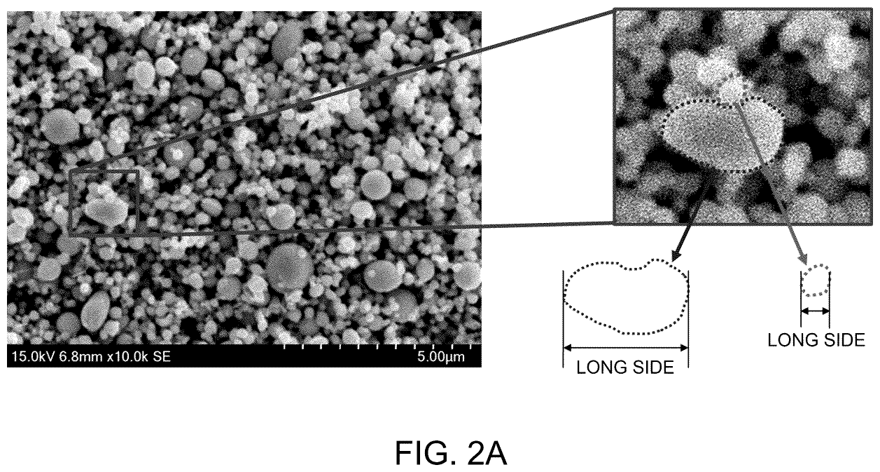

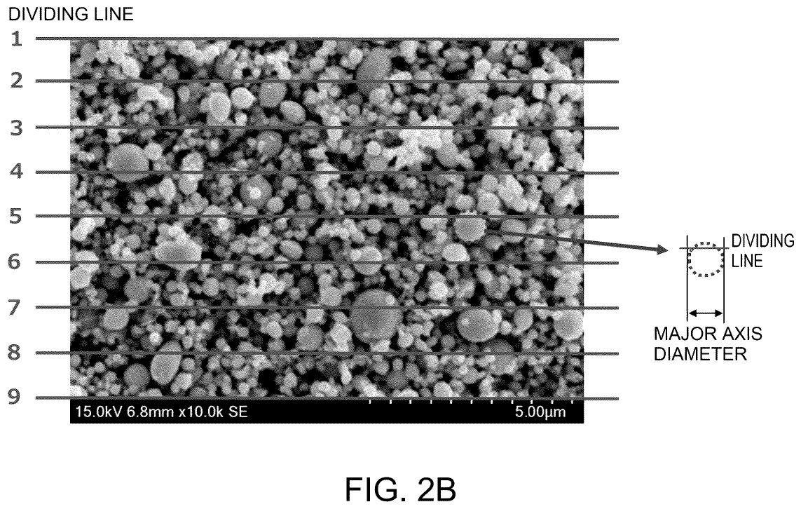

The average major axis diameter of Bi₂O₃ powder was calculated as follows. First, the Bi₂O₃ powder was observed using a scanning electron microscope (SEM SU-3500, manufactured by Hitachi High-Tech Corporation) at a magnification in which 1,000 or more of Bi₂O₃ particles (primary particles) are included in an arbitrary field of view. The acquired SEM images are shown in FIGS. 2A and 2B. The magnification in FIGS. 2A and 2B is 10,000 times and the observation field of view is 12.5×8.5 μm. As shown in FIG. 2A, the length of long side in the Bi₂O₃ particle was defined as a “major axis diameter.” Then, as shown in FIG. 2B, the acquired SEM image was imported into image processing software (Adobe Illustrator, manufactured by Adobe, Inc.), and nine dividing lines were drawn in the horizontal direction so as to divide the observation field of view into eight sections in equally spaced manner. Of the second to eighth dividing lines, excluding the two lines at both ends, particles that touched or crossed one or more of each line were extracted. The major axis diameters were measured for each extracted particle, and the average value thereof was determined as the “average major axis diameter.” Of the major axis diameters of each particle as measured by the above method, the largest major axis diameter was defined as the “maximum major axis diameter,” which will be described below.

According to the proportion compounded shown in Table 1, to the ZnO particles were added the metallic Zn powder, polytetrafluoroethylene (PTFE) as well as Bi₂O₃ powder, if necessary, and the mixture was kneaded together with propylene glycol. It is noted that the amount of PTFE added was 1.7 parts by weight relative to 100 parts by weight of ZnO particles. The obtained kneaded product was rolled by a roll press to obtain a negative electrode active material sheet. The negative electrode active material sheet was compressed and adhered to a tin-plated copper expanded metal to obtain a negative electrode.

### (3) Preparation of Electrolytic Solution

Ion-exchanged water was added to a 48% potassium hydroxide aqueous solution (manufactured by Kanto Chemical Co., Inc., special grade) to adjust the KOH concentration to 5.4 mol %, and then zinc oxide was dissolved at 0.42 mol/L by heating and stirring to obtain an electrolytic solution.

### (4) Fabrication of Evaluation Cell

The positive electrode and the negative electrode were each wrapped with a nonwoven fabric, and each welded with a current extraction terminal. The positive electrode and the negative electrode thus fabricated were opposed to each other with the LDH separator interposed therebetween, sandwiched by a laminated film provided with a current extraction port, and the laminated film was heat-sealed on three sides thereof. The electrolytic solution was added to the obtained cell container with the upper side being opened, and was sufficiently permeated into the positive electrode and the negative electrode by vacuum evacuation, etc. Thereafter the remaining one side of the laminated film was also heat-sealed to form a simply sealed cell.

### (5) Evaluation

### <Cycle Characteristics>

Chemical conversion was carried out on the simply sealed cell with 0.1C charge and 0.2C discharge by using a charge/discharge apparatus (TOSCAT3100 manufactured by Toyo System Co., Ltd.). Then, a 1C charge/discharge cycle was carried out. Repeated charge/discharge cycles were carried out under the same conditions, and the number of charge/discharge cycles until a discharging capacity decreased to 70% of the discharging capacity of the first cycle of the prototype battery was recorded, the procedure of which was adopted as an indicator of cycle characteristics. The results are shown in Table 1, confirming that for the negative electrodes with various compositions, the addition of Bi₂O₃ particles in the range of 0.5 to 20 parts by weight relative to 100 parts by weight of ZnO particles, improved the cycle characteristics.

TABLE 1

| | Negative electrode composition | | | |
|---|---|---|---|---|
| | ZnO (parts | Zn (parts | Bi₂O₃ (parts | The number |
| | by weight) | by weight) | by weight) | of cycles |
| Example 1* | 100 | 51 | 0 | 620 |
| Example 2 | 100 | 51 | 1.2 | 770 |
| Example 3 | 100 | 51 | 3.3 | 800 |
| Example 4 | 100 | 51 | 6.6 | 740 |
| Example 5 | 100 | 51 | 13.6 | 700 |
| Example 6 | 100 | 51 | 18.2 | 660 |
| Example 7* | 100 | 51 | 22.7 | 400 |
| Example 8* | 100 | 5.7 | 0 | 550 |
| Example 9 | 100 | 5.7 | 0.9 | 600 |
| Example 10 | 100 | 5.7 | 2.4 | 750 |
| Example 11 | 100 | 5.7 | 4.9 | 620 |

*denotes Comparative Example

### Examples 12 to 22

For Examples 12 and 14, evaluation cells were fabricated in the same manner as in Example 1 and Example 3, respectively, and for Examples 13 and 15 to 22, evaluation cells were fabricated in the same manner as in Example 3, except that the powder was changed to commercially available Bi₂O₃ powder as shown below.

<Bi₂O₃ Powder>
Examples 13 and 19: Bi₂O₃ powder manufactured by Vital Materials, Co., Ltd., average major axis diameter: as shown in Table 2
Examples 15 to 18 and 22: Bi₂O₃ powder manufactured by 5N Plus Inc., average major axis diameter: as shown in Table 2
Examples 20 and 21: Bi₂O₃ powder manufactured by KOJUNDO CHEMICAL LABORATORY CO., LTD., average major axis diameter: as shown in Table 2

The obtained evaluation cells underwent evaluation for their cycle characteristics in the same manner as in Examples 1 to 11. The results are as shown in Table 2, confirming that the cycle characteristics were improved by setting the average major axis diameter of Bi₂O₃ particles within the range of 0.3 to 8.5 μm. In addition, the negative electrodes before evaluating the cycle characteristics in Examples 13 to 22 were confirmed for the presence or absence of aggregation described below.

### <Presence or Absence of Aggregation>

After the negative electrode was embedded in a resin and was cross-sectionally polished, the polished negative electrode cross-section was observed with a scanning electron microscope (SEM SU-3500, manufactured by Hitachi High-Tech Corporation) at a magnification of 1,000 times. The negative electrode observation range was 10 mm, and cross-sectional SEM images were acquired at 1 mm intervals of the range over a field of view range of 125 μm×85 μm (11 fields of view in total). Of the obtained cross-sectional SEM images, in a case in which aggregation of Bi₂O₃ particles was confirmed in two or more fields of view, the case was determined to be in the presence of aggregation. As a result, it was determined that Examples 13 to 18 and 21 were in the presence of aggregation, and Examples 19, 20, and 22 were in the absence of aggregation.

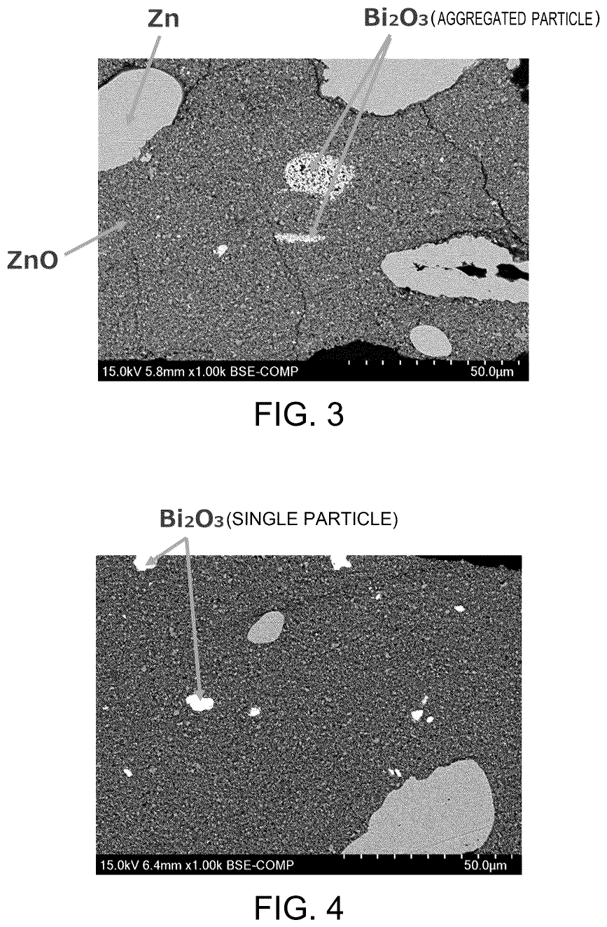

For reference, the cross-sectional SEM images of the negative electrodes obtained in Examples 14 and 20 are shown in FIGS. 3 and 4, respectively. As shown in FIG. 3, the negative electrode fabricated in Example 14 was confirmed to have Bi₂O₃ particles at least partially present in the form of aggregated particles. As shown in FIG. 4, on the other hand, the negative electrode fabricated in Example 20 was confirmed to have Bi₂O₃ particles in the form of single particles. Herein, as shown in Table 2, the addition of Bi₂O₃ particles in both Examples 14 and 20 improved the cycle characteristics; however, in Example 20, it is considered that more Bi₂O₃ particles in the form of primary particles are present in the negative electrode, resulting in having further improved the cycle characteristics than in Example 14.

TABLE 2

| | Average major axis diameter | The number |
|---|---|---|
| | of Bi₂O₃ particles (μm) | of cycles |
| Example 12* | — | 620 |
| Example 13 | 0.3 | 680 |
| Example 14 | 0.5 | 800 |
| Example 15 | 0.8 | 680 |
| Example 16 | 1.1 | 690 |
| Example 17 | 1.2 | 760 |
| Example 18 | 2.0 | 810 |
| Example 19 | 3.5 | 920 |
| Example 20 | 5.0 | 1110 |
| Example 21 | 8.5 | 750 |
| Example 22* | 10.4 | 500 |

*denotes Comparative Example

### Examples 23 to 27

For Examples 23, 24, and 26, evaluation cells were fabricated in the same manner as in Examples 1, 17, and 20, respectively, and for Examples 25 and 27, evaluation cells were fabricated in the same manner as in Example 3, except that the powder was changed to commercially available Bi₂O₃ powder as shown below.

<Bi₂O₃ Powder>
Example 25: Bi₂O₃ powder manufactured by TAIYO KOKO Co., LTD., average major axis diameter and maximum major axis diameter: as shown in Table 3
Example 27: Bi₂O₃ powder manufactured by 5N Plus Inc., average major axis diameter and maximum major axis diameter: as shown in Table 3

The obtained evaluation cells underwent evaluation for their cycle characteristics in the same manner as in Examples 1 to 11. The results are as shown in Table 3, confirming that for each Example in which the average major axis diameter of Bi₂O₃ particles was identical, the smaller the maximum major axis diameter (i.e., the narrower the particle size distribution), the more the cycle characteristics improve.

TABLE 3

| | Bi₂O₃ particles | | |
|---|---|---|---|
| | Average | Maximum | |
| | major axis | major axis | The number |
| | diameter (μm) | diameter (μm) | of cycles |
| Example 23* | — | — | 620 |
| Example 24 | 1.2 | 2.5 | 760 |
| Example 25 | 1.2 | 25 | 710 |
| Example 26 | 5.0 | 15 | 1110 |
| Example 27 | 5.0 | 35 | 640 |

*denotes Comparative Example

What is claimed is:

1. A negative electrode for use in a zinc secondary battery, comprising:
ZnO particles,
metallic Zn particles having an average particle diameter D50 of 85 to 250 μm, and
Bi₂O₃ particles having an average major axis diameter of 0.3 to 8.5 μm,
wherein the content of the metallic Zn particles is 1.0 to 87.5 parts by weight and the content of the Bi₂O₃ particles is 0.5 to 20 parts by weight, based on the content of the ZnO particles being 100 parts by weight.

2. The negative electrode according to claim 1, wherein the content of the Bi₂O₃ particles is 1.2 to 13.6 parts by weight, based on the content of the ZnO particles being 100 parts by weight.

3. The negative electrode according to claim 1, wherein the Bi₂O₃ particles have the average major axis diameter of 1.2 to 8.5 μm.

4. The negative electrode according to claim 1, wherein the Bi₂O₃ particles have a maximum major axis diameter of less than 35 μm.

5. The negative electrode according to claim 1, wherein the Bi₂O₃ particles are present on a surface of the ZnO particles.

6. The negative electrode according to claim 1, wherein the Bi₂O₃ particles are comprised in the form of non-aggregated primary particles.

7. The negative electrode according to claim 1, wherein the negative electrode is a sheet-like pressed product.

8. A zinc secondary battery, comprising:
a positive electrode,
the negative electrode according to claim 1,
a separator separating the positive electrode from the negative electrode so as to be capable of conducting hydroxide ions therethrough, and
an electrolytic solution.

9. The zinc secondary battery according to claim 8, wherein the separator is an LDH separator comprising a layered double hydroxide (LDH) and/or an LDH-like compound.

10. The zinc secondary battery according to claim 9, wherein the LDH separator is composited with a porous substrate.

11. The zinc secondary battery according to claim 8, wherein the positive electrode comprises nickel hydroxide and/or nickel oxyhydroxide whereby the zinc secondary battery forms a nickel-zinc secondary battery.

12. The zinc secondary battery according to claim 8, wherein the positive electrode is an air electrode whereby the zinc secondary battery forms a zinc-air secondary battery.
